(19) United States
(12) Patent Application Publication
(10) Pub. No.: US 2014/0358764 A1
(43) Pub. Date: Dec. 4, 2014

(54) SYSTEM AND METHODS FOR VALUING AND TRADING INTANGIBLE PROPERTIES AND INSTRUMENTS

(71) Applicant: Ocean Tomo LLC, Chicago, IL (US)

(72) Inventors: Dean Becker, Chicago, IL (US); Christine Alexis Bante, Chicago, IL (US); Cameron Gray, Chicago, IL (US); James E. Malackowski, Chicago, IL (US); Dipanjan Nag, Chicago, IL (US)

(21) Appl. No.: 14/461,034

(22) Filed: Aug. 15, 2014

Related U.S. Application Data
(63) Continuation of application No. 12/671,426, filed on Jul. 13, 2011.
(60) Provisional application No. 60/955,832, filed on Aug. 14, 2007.
(60) Provisional application No. 61/062,962, filed on Jan. 29, 2008.
(60) Provisional application No. 61/072,620, filed on Mar. 31, 2008.

(51) Int. Cl. G06Q 40/04

(52) U.S. Cl. CPC G06Q 40/04
USPC 705/37

(57) ABSTRACT

A system and methods providing an exchange network for valuing and trading of intangible instruments, such as one or more rights to an intangible property including a given intellectual property (patents, copyrights, trademarks, trade dress, trade secrets and/or the rights of publicity). The system and methods permits a party to access a database of the intangible instruments including data relating to identifying value of the instrument. The system and methods permits a party to perform due diligence on the intangible instrument and, as a result, to formulate a bidding strategy for the intangible instrument that the bidder believes is appropriate. If the bidder and the owner reach agreement on the price, a transaction for the intangible instrument is executed between the parties.

This application claims priority to U.S. patent application Ser. No. 12/671,426 filed on Jul. 13, 2011, which is a national application of International Application No. PCT/US08/09769 filed Aug. 14, 2008, which claims priority to U.S. Provisional Patent Application No. 60/955,832 filed Aug. 14, 2007, U.S. Provisional Patent Application No. 61/062,962 filed Jan. 29, 2008, and U.S. Provisional Patent Application No. 61/072,620 filed Mar. 31, 2008.

### FIELD OF THE INVENTION

The present invention relates generally to a valuation and exchange network. More particularly, the present invention relates to a system and method by which intangible rights, including those rights associated with intellectual properties, may be valued by buyers or sellers and depending on the valuation, property and rights exchanged.

### BACKGROUND OF THE INVENTION

Intangible property is that collection of rights which can be owned but which has no physical substance. As with forms of tangible property, an owner of intangible property can transfer all or some limited portions of the property to another or others. More specifically, the owner of intangible property permits another or others to exercise one or more of the complete collection of rights that defines the intangible property. The question is at what price should that transfer (or the exchange of the interest or rights for some form of consideration, such as money) take place. The transfer or exchange of intangible property has been historically hindered by the fact that there is no controlled marketplace in which intangible property interests can be offered and thereby valued, and, if the desired valuation is achieved, an exchange of the desired property interests and, and for example, money can take place.

The current system is not standardized and highly inefficient. For example, a potential buyer must identify the intangible property to which he or she wishes to direct an offer, locate the owner of the property, establish whether and to what extent the owner is willing to engage in negotiations with respect to the exchange of the desired property interests, seek documentation that establishes that the title to the property is clear (or at least has all encumbrances identified), present the offer, respond to counter-offers, and, if and when the offer is acceptable to the owner/seller, obtain appropriate documentation signifying that the seller has transferred and the buyer has obtained the desired property interest. Similarly, an owner desiring to sell an intangible property, or at least a partial interest in same, (such as through a licensing agreement) must determine the value of the property or partial interest. This is no easy task given that transactions in which intangible property is sold or partial interests (such as through a license) transferred are rarely detailed in public. Given the lack of comparability (by which real property is commonly valued), what the owner of the intangible property can obtain from the sale of the property (or from the transfer of a partial interest) is most often no more than a guess. Once the owner decides what is the appropriate value of the property interests to be transferred, the owner must then identify whether there is any potential buyer or bidders who may desire to place a bid or bids on the property interest that the owner wishes to transfer, offer the property to the identified potential buyers, handle the anticipated responses, including, if any, from the same, reply to the possible bids, select from hopefully the more than one desired bid, then close the transaction such that the owner obtains from the successful bidder the desired money and/or other consideration for the subject property interest transfer. It is largely only at the end of this process that an appropriate valuation of the subject intangible property interest is established.

This current process is clearly both time consuming and expensive. Property owners must actively pursue potential buyers and vice versa. The lack of readily available comparables for intangible property interest in any given marketplace always means that expectations regarding value may not be in line with reality and that possibly protracted negotiations over at least prices are part of the process.

The end result of the process often is not satisfying to the parties to the transaction. The limited marketplace in which intangible property is offered may produce a skewed valuation. A more robust, more open marketplace can help to establish a more readily accepted value on the property.

Additionally, current systems and methods fail to provide a readily accessible and efficient source for data relating to intangible properties and/or intangible instruments. Whether seeking to buy, sell, or simply understand the current market—broadly or by region or country or by technology, content, or subject matter—for intangible properties or instruments, the current system fails to provide worldwide data in a convenient, consolidated, and efficient source.

Auctions are available at which certain intangible properties—that is, intellectual properties—are traded. However, these auctions offer and sell intellectual properties such as patents typically very small number of bidders. As a result, it is generally a mostly fragmented market. Potential buyers can view and bid on only the intellectual properties being actively offered and cannot view a wider range of properties. Valuations are accordingly limited.

Another problem with auctions is that the property that is of interest to a potential bidder may not be offered at all during one or subsequent auctions. Also, at any one auction, if a certain intellectual property is offered, the bidder may have to wait for a long period of time until a bid can be made on the target property.

Convenient marketplaces exist for trading other types of instruments, such as stocks and other securities, commodities, futures, and even environmental emissions permits. For example, various exchanges, such as the New York Stock Exchange (“NYSE”), actively trade stocks and securities. Other exchanges, such as the Chicago Board of Trade (“CBOT”) actively trade commodities and futures. And while most trading activity today is performed electronically, some exchanges such as the National Association of Securities Dealers Automated Quotations (“NASDAQ”) are entirely traded electronically without utilizing a centralized trading floor. These trading exchanges allow for instruments such as stocks and securities to be quickly and easily traded, both upon the initial public offering (“IPO”) and during subsequent day-to-day transactions. Other exchanges include Chicago Mercantile Exchange (“CME”), Chicago Board Options Exchange (“CBOE”), International Securities Exchange (“ISE”), Boston Options Exchange (“BOX”), Philadelphia Stock Exchange (“PHLX”), New York Mercantile Exchange (“NYMEX”), Archipelago Exchange (“ArcaEx”), American Stock Exchange (“AMEX”), Pacific Exchange (“PCX”). As a result, owners of such instruments have an immediate market for trading and do not have to spend months seeking out potential buyers or sellers and negotiating prices.

These systems, however, do not facilitate the trading of all or some portion intangible property. For purposes of this application, the term “intangible property” includes intellectual property—patents, copyrights, trademark rights, trade secrets, the rights of publicity—and other non-tangible properties and interests, such as those that arise from documents or information describing new technologies (including written disclosures, sets of equations or algorithms, laboratory notebooks and data sets), new content (including descriptions, manuscripts, and treatments from which novels, screenplays, and movies may be produced), and those that define use, exploitation, and exploration rights (including broadcast rights, land use rights, prospector's claims, mineral rights, water rights, and air rights), fishing rights, taxi medallions, and naming rights.

Accordingly, there is a need for a system and methods by which transactions directed to intangible property may be efficiently handled and as a result of which intangible property may be valued. The present invention satisfies the demand.

### SUMMARY OF THE INVENTION

The invention is a system and methods providing a valuation and exchange network that facilitate transactions directed to intangible properties and instruments in an efficient, secure, and timely manner. The present invention advantageously also provides a system and methods by which the value of an intangible property and/or intangible instrument—for example, the price at which intangible properties or instruments may be bought or sold or licensed—may be efficiently known or identified.

For purposes of this application, the term “intangible instrument” means any type of an interest or right in an intangible property. By definition, intangible properties cannot be seen, touched or physically measured. Intangible property is a non-monetary asset and includes intellectual property such as patents, patent applications, invention disclosures, copyrights, trademarks, trade dress, trade secrets, and the rights of publicity. Intangible property may also include naming rights, customer lists, knowledge, know-how, research and development, collaboration activities, leverage activities, relationships, and systems such as taxi medallion systems. The actual intangible instrument that is offered, valued, and exchanged through the subject network can be, for example, all of the rights arising out of a patent grant, or all of the rights associated with a copyright registration or a trademark registration. The actual intangible instrument may also be a group of rights less than all of the rights arising, for example, from a patent grant or copyright registration or trademark registration. For example, the intangible instrument may be an exclusive license to practice one or more of the statutory or judicially-based rights that a patent, copyright, or trademark provides.

For purposes of this application, the term “clearing house” means that which in certain preferred embodiments manages, operates, and otherwise oversees, one or more exchange networks. More specifically, in certain in certain embodiments, the clearing house may manage the one or more exchange networks such as by interacting with the public, customers, and other users of the system, establishing, maintaining and controlling the relevant databases and data rooms of due diligence materials, regulating parties of the exchange network, as well as verifying information such as a patent number or patent ownership. In certain embodiments, the clearing house may also provide brokerage services between parties and further may provide clearing and settlement services for transactions.

For the purpose of this application, the term “exchange network” is the medium by which transactions take place. The exchange network may be automated, semi-automated, or non-automated. An automated exchange network may be online such as via the Internet. A non-automated exchange network may, in certain embodiments, utilize a trading venue such as a trading floor or trading room. A semi-automated exchange network may be a combination of both.

In certain embodiments, the exchange network may also include a plurality of exchange networks. Exchange networks may further be compartmentalized or directed. For example, one or more of the exchange networks may be directed to a certain language, currency, geography, and/or even subject matter. An example of a subject matter compartmentalized exchange network is one directed to nanotechnology patent subject matter. It is further contemplated that each compartmentalized exchange network may be managed by its own clearing house.

For purposes of this application, the term “party” or “parties” includes a customer of the system, bidder, buyer or licensee, seller or licensor, and may be a private individual, a business, or a legal entity, for example, a trust. “Public” generally identifies those that are not a customer of the system and may also be referred to herein as “potential buyer” or “potential seller”. For purposes of this application, the term “buyer” generally identifies both a purchaser of all rights and a licensee of less than all of the rights that define a subject intangible property. The term “bidder” means a party that, for example, has registered and directs an offer to the subject intangible property by placing a bid or bids. “Seller” generally identifies the owner of the subject intangible property and a licensor of less than all of the rights that define the subject intangible property.

Transactions are the trading actions directed to the intangible instrument and include standard transactions and non-standard transactions. For the purposes of this application, standard transactions include, for example, a full sale or purchase of the intellectual property or a fully paid up exclusive license with no royalties. Also, for the purpose of this application, a non-standard transaction includes, for example, a license with an up front fee such as a fee to cover the cost of the transaction and an end royalty such as an amount, percentage, or set amount due at the end of the license term. A non-standard transaction also includes a non-exclusive license.

Trading actions include a purchase and a license. The term “purchase” includes offers to buy and sell an intangible property. “Buy” is to exchange, trade, or purchase for money or its equivalent. “Sell” is to exchange or deliver for money or its equivalent. “License” is to exchange a certain right or rights for money or its equivalent and includes exclusive and non-exclusive licenses. For example, an offer for an exclusive license to a patent may refer to a one-time upfront, lump-sum payment with no running royalty or a one-time upfront, lump-sum payment in addition to a fixed running royalty rate such as 5% of gross sales.

Offers may include a firm offer, reserve offer, limit offer, or a market offer including a cap and an increment. A cap is a maximum limit and an increment is an increase, either of some fixed or variable amount. For example, a firm offer may be $10,000 or a market offer may be $5,000 with a cap at $12,500 and an increment of $2,500. Offers may further be subject to a minimum amount per intangible instrument, for example $1000. Offers may also be contingent upon some conditions including that there are no liens or encumbrances on the intangible instrument. Offers may be active for a set period of time such as six months or until cancelled, although the clearing house may tender an intangible instrument beyond expiration.

An offer may include also bids and asks. A “bid” is the price point where a potential buyer is willing to purchase a given intangible instrument. This is the price a seller typically receives when an intangible instrument is sold or licensed. “Ask” is the price point where a seller would be willing to sell an intangible instrument. This is the price paid when an intangible instrument is bought or licensed by a buyer.

Certain embodiments of the system permit the bidders and sellers to contact the exchange network at any time regarding bids and asks, such as to lift an offer, hit a bid, change a bid, change an offer, or obtain a quote on the current market for an intangible instrument. The parties may further counter-bid and counter-ask.

The term “active transaction” for purposes of this application means that state in the transaction process after an intangible instrument has been offered for sale or license and during which the opportunity to bid remains open for a period of time. The term “inactive transaction” means that state after an offer has been accepted or the offer has been cancelled or the bidding period has expired. For example, a transaction may be considered to be an active transaction or “live” for purposes of this application for a six month period of time. After that, the transaction may be considered to be “inactive”. “Transaction activity” includes the current and historic activity levels, bid/offer spreads, bid/offer frequency, number of bids/offers, bidder identities, and bidder patterns to name a few.

Among other advantages, the present invention provides an efficient and cost effective system and method by which all parties are able to communicate and exchange offers for intangible instruments. In embodiments where the exchange network is automated or semi-automated, the exchange network may include various screen displays that permit transactions to be conducted with respect to specific intangible instruments. Parties may view the current bid and ask prices for intangible instruments through the various screen displays at the online exchange network or through other displays that may be portable. Bidders will be able to place an offer to buy or license and sellers will be able to place an offer to sell or license an intangible instrument such as a patent, family of patents, or portfolio of patents.

In certain embodiments, the public may browse certain features and components of the online exchange network for the transaction activity for some or all intangible instruments, such as patents, patent applications, invention disclosures, patents within a family, corresponding foreign patents and applications, and similar patents. The public may assess value of an intangible instrument, in part, based upon the bids and offers posted for comparable intangible instruments. In certain embodiments, the public may be permitted access to only information regarding active transactions without registration such as a buyer, seller, or customer. Other embodiments may permit the public to obtain information regarding formerly active transactions—such as the number, size, and timing of bids—only after registration as a system customer, and for example, after the payment of a fee for such information related services.

Certain embodiments of the clearing house archives data such as transaction activity from the active transactions and inactive transactions via a database. It is also contemplated that the clearing house may obtain and archive data from external sources, for example, information regarding intellectual property not subject to the exchange network or information regarding litigation of an intellectual property subject to the exchange network.

The present invention provides an open platform of all intangible properties and instruments worldwide. The platform is a default resource for identifying global value data for intangible properties and instruments. For purposes of this application, value data may include market worth and estimated worth, for example, in terms of a monetary value or price. This global value data assists in understanding the market for intangible properties and instruments as well as market efficiency. For purposes of this application, market may be worldwide or by region or country or by technology, content, or subject matter.

Browsing and searching through the database includes the process known as “data mining”. More specifically, data mining is the process of sorting through large amounts of data and selecting data of interest, or relevant data. Data mining may include filters to facilitate the more precise sorting through the data to find only certain information. For example, filters may include sorting that permits the identification of one or more of the following: active bids; active asks; intangible instruments with a populated data room; a specific transaction type such as lump sum payment, assignment, terms of an exclusive license; success of a non-exclusive license, country such as geographic region and/or intellectual property governing organizations, for example, European Patent Office; bid amount or ask amount which can be any value, for example greater or equal to 1000£ or greater than $5,000,000; and exclusion or inclusion of something, for example a specific event such as an auction or interest by particular company.

In one embodiment, the present invention allows a party to identify value of one or more intangible properties. To establish such value, one or more database related to one or more intangible properties may be accessed and that data which is maintained within the database is browsed. Data may be sorted, such as by filtering the data, to produce select data. The select data is relevant to some or all of the intangible properties. In certain embodiment, certain data is available to the public. In other embodiments, certain data may be made available only to customers.

The system permits in certain embodiments the production of reports from the processing of the data. Certain embodiments may provide parties unrestricted access to certain reports whereas those that may not have been the seller or a potential or actual buyer may be required to register and purchase the report from the clearing house. Reports may include, for example, limitation of license terms and how those limitations may have affected the value of the intangible property or instrument and further in certain markets. An example of a report may be, for example, include the amount received by a Japanese patent directed to a certain subject matter such as microbiology in comparison to the amount received by a United States patent of the same patent family or of a different patent family, but relating to the same subject matter. Reports may also include intangible property trends or evaluations for intangible instruments in different geographic areas.

The clearing house may also provide trading alerts. For purposes of this application, the term “trading alert” means a notification regarding certain subject matter, intangible property or intangible instrument to fluctuations in the exchange network and potential buys and sells. It is contemplated that in certain embodiments the trading alert can be sent to a computer, cell phone, or instant messaging service (AIM, MSN, Yahoo and so on) at any time of day or night. The clearing house may offer trading alerts to registered parties or to the public and may further offer alerts for a fee.

Further advantageously, if a public member, potential buyer, or potential licensee (collectively termed herein also as “potential buyer”) is interested in, selling or licensing an intangible instrument, the person contacts the exchange network such as through any communication method including online or toll free phone number. Similarly, a public member seeking to place a bid to purchase or license an intangible instrument listed on the exchange network, the person or entity may contact the exchange network. After contacting the exchange network, the clearing house registers the public member so that they can be considered “parties’ and may conduct transactions on the exchange network. Registration may include, for example, providing a bidder a bidder identification number or name to protect the anonymity of the party's investing behavior, such as when a bidder may bid on multiple intangible instruments or families of intangible instruments. The buyer or seller may be required to pay one or more fees. These may include bidding fees, selling fees, earnest fees, and service fees.

The offer may include a license, for example, a standard transaction of a full paid up exclusive license with no royalties. The party may define the terms of the license offered. For example, the licensor may limit the licensee so that no warranties, no representations and indemnification are provided thereunder. In one embodiment, the license is created by a party using an automated form system provided by the clearing house for use on the exchange network. The automated form may be customizable and include options selected via drop down boxes or links for terms of the agreement. In another embodiment, it is contemplated that the public can view all the options of the license as well as the option selected by the party. It is contemplated the automated form system provided by the clearing house for use on the exchange network may be used, for example, a party to prepare agreements or documents other than a license, for example, a non-disclosure agreement or a confidentiality agreement.

In one embodiment, the system provides for the formation of an agreement through the online exchange network using a selection process. For example, an agreement screen displays particular provisions of the agreement to a user. The user may insert agreement language selected through the online selection process using a plurality of online screens. Each online screen displays to the user one or more selections of the agreement language and from which the user may select and thereby have inserted the agreement language in the agreement.

With respect to fees, one embodiment of the present system requires that the potential bidder to pay a fee to place a bid on an intangible instrument. The bidding fee charged by the clearing house to receive an initial bid from a potential buyer may be, for example, $250. If the potential buyer wishes to bid on multiple, but related intangible instruments, the bidding fee may be the same fee as for one intangible instrument. Bidding fees can not only be a flat rate but also a percentage of the bid. Bidding fees may also include fees for subsequent bids, such as $50, to encourage bidders to place incremental, as opposed to final offers.

Embodiments of the present system may require that the bidder place an amount in a holding account as an “earnest payment” or “earnest fee”. The earnest fee may be a percentage of the bid and are held in an account by the clearing house. For example, if the potential buyer wishes to bid on a single intangible instrument, the earnest fees may be 10% of the bid amount. Further, the earnest fees may be contingent upon the seller representing and warranting that he or she can transact according to a seller agreement. The earnest fees may be applied toward the purchase of the intangible instrument. If the seller accepts the offer, the earnest fee is held in the account until closing and then applied to reduce the final amount that the bidder must pay to settle the transaction. If the seller retracts the offer, the earnest fee is returned to the bidder. If the bidder retracts the bid or fails to settle the account, some or all of the earnest fee may be transferred to the seller. Certain embodiments of the system permit the clearing house to keep a portion of the earnest fee, such as for a failure to settle a transaction.

Selling fees are fees charged by the clearing house to receive an initial ask from a seller, for example, $250. Selling fees may also include fees for subsequent asks, such as $50, to encourage sellers to place incremental, as opposed to final offers.

Certain embodiments of the present invention include a data room operated and managed by the clearing house. For purposes of this application, the term “data room” means a central location allowing for information, such as due diligence materials, to be made available as needed. Certain embodiments of the data room may permit access only to the seller and those actually placing a bid. Other embodiments of the data room may be “tiered”—that is, have certain information available only in certain circumstances. For example, one tier of a “tiered data room” may provide information—such as information that is generally publicly available—to potential buyers. While in this embodiment the public is provided access to a first level, or “tier” of public domain information, such as a patent file history, other embodiments may include one or more additional tiers. For example, only registered persons or entities or actual sellers or those actually placing a bid may gain access to a second level of information—such as that tier that includes information not readily available to the public. A third level or tier may be available that includes confidential information, for example, sales data but only, for example, if the bidder executes a confidentiality agreement. It is contemplated that in certain embodiments the public may have access to certain levels of information such as upon payment of a fee to the clearing house.

The clearing house may charge the seller data room fees, for example $495, to maintain the data room, The data room, which may include due diligence materials, such as prosecution histories, prior art, licenses, liens, and/or litigation materials, and enable those gaining access to the room to perform an investigation on the intangible instrument. Additionally, if a seller does not provide some or all of what may be considered to be standard due diligence materials in the data room, an embodiment of the system permits a seller to provide a written confirmation—such as an affidavit—directed to the deficiency, such as that there are no liens on the intangible instrument and that the seller has the right to sell the subject instrument or property. An embodiment of the data room may also be organized to include components by which the parties may engage in inter-parties communications such as in the form of a private chat room for the parties to communicate.

Certain embodiments of the system charge commission fees for closed, or completed, transactions. The commission fee may be, for example, shared equally between the buyer and seller, or licensor and licensee. The clearing house may also obtain a commission fee of a flat rate or a percentage, for example, 15% of the final accepted offer. Embodiments of the present system may provide also that if the transaction does not close, the buyer or seller may be assessed a fee that is taken out of the earnest fee. For example, if the seller retracts the offer, the buyer may be returned the earnest fee but with the clearing house receiving 15% of the earnest fee.

For purposes of this application, the term “service fees” means any remaining fee that may be charged by the clearing house for one or more various business activities, such as assignment recording, title transfer documents, email notifications regarding transaction activity, and insurance directed to the ownership of the intangible properties and instruments. Service fees can also include subscriptions by which a seller can offer or a bidder can bid on many intangible instruments during a set period of time. For example, with a monthly or annual bidding subscription, a bidder can place up to 25 offers for one monthly fee of, for example, $1,000. For an annual subscription fee of $10,000, the bidder may be able to place up to 250 bids in the exchange network.

After the fees required by the particular embodiment of the exchange have been received, the exchange permits the customer to place his or her bid or the seller to place his or her ask with the online exchange network.

Advantageously, certain embodiments of the present invention are standardized to provide uniform processes and methods for a bidder's bid and a seller's ask. For example, the system may utilize standardized contracts by which all of the transactions are conducted, thereby providing efficiencies that the current system does not provide. It is contemplated that in certain circumstances parties may require deviation from the standardized system, such as contract terms that permit a large volume transaction to occur.

If a bidder places a bid, the clearing house then contacts the seller to notify them that a party is interested in purchasing or licensing their intangible instrument. If the seller is not interested, the seller can take no further action and, the bid is cancelled or just expires, such as, for example, six months from the bidder's bid on the intangible instrument. If the seller is interested and wishes to accept the offer, the clearing house registers the sale and closes the transaction. If the seller is interested but not at the price offered by the potential buyer, or the conditions set by the potential buyer, the seller can respond accordingly and engage in a negotiation process.

An offer may also be communicated via a form wherein the bidder enters an identifier for the intangible property or intangible instrument along with the bid amount and bid type within the form. The bidder may enter more than one identifier such as in a string format by separating each identifier with a symbol, for example, a colon, comma, space, or hyphen. Upon submitting the form, the clearing house may review the submission either automatically or manually or both to verify the offer and may further confirm the offer with the bidder. For example, the clearing house may communicate via email with the bidder by sending verification information regarding the intangible property or intangible instrument, such as the abstract of a patent, claims of a patent, or visual representation of a trademark, for the bidder to review.

The asking price, or offer, may be active for a period of time, for example, six months from the date that the agreement—such as affidavit—is received from the seller by the exchange network, or until cancelled by the seller. If a potential buyer is interested in transacting on a particular intangible instrument, such as purchasing or exclusively licensing a particular patent, the potential buyer can then contact the exchange network.

The bidder may cancel a current bid, cancel a current bid and place a revised bid, or take no action wherein the bid remains active. If no transaction results, the bidder's offer is no longer active and the earnest fee is returned. Otherwise, the bid and offer may remain active until expiration, such as six months from placement, or until otherwise cancelled. If the bidder and seller agree to a purchase price for the intangible instrument, the clearing house will close the transaction. Offers for and the actual price at which a transaction for an intangible instrument took place and the timing of such bids, for example, can be archived for later use in valuation exercises, for example to assist in understanding the market for intangible properties and instruments as well as market efficiency. During the entire transaction, the clearing house updates the display in embodiments where the exchange network is online.

A potential buyer may browse and search a collection or a database of intangible instruments through a display, or screen, offered through the online exchange network. In one embodiment of the present invention, the display of the online exchange network provides a list of the intangible instruments that are available for sale or licensing. The display includes a unique identifier for each of the listed intangible instruments. If the list is of patents or patent applications, the unique identifier can be the patent number or the patent application serial number, or the patent publication number which the relevant government office provides. If the list is of trademarks available for sale or licensing, the unique identifier may be the number issued by the relevant government office for the trademark registration or pending registration application. The list may also be directed to intangible instruments or properties for which a government office has not generated unique identifiers. One example of such an instrument is an invention disclosure. In such a case, the display may show a unique identifier for each such intangible instrument that the seller generated or which the clearing house generated (possibly with the input of the seller). The screen also illustrates the entity associated with, or that published, the intangible instrument identifier, such as a university, a “party” or “parties” as defined above, or national, regional, or international government office.

The screen may also illustrate whether or not the data room is available for the particular intangible instrument and whether and to what extent is populated with due diligence materials. The screen may indicate whether the data room includes a private chat room or similar communication vehicle through the use of which the parties to communicate.

Embodiments of the screen can illustrate the current offers—bid price and ask price—for either the outright sale or purchase of the intangible instrument or the sale or purchase of a license for the intangible instrument.

The clearing house works closely with bidders to ensure the confidentiality of their bidding information, including acquisition trends and maximum bid amounts, and the identity of the bidder. To encourage the participation of all prospective buyers, certain embodiments of the present invention implement a discrete bidder identification system that may prevent viewers from determining bidder identities.

A bidder identification field on the display illustrates each party's unique bidder identification number. Certain embodiments of the system permit the same party to have multiple unique bidder identification numbers to protect the anonymity of a party's investing behavior, such as when a bidder may bid on multiple intangible instruments or families of intangible instruments.

For every asset identifier, the expiration date of the offer is posted, provided an expiration date exists. For example, the expiration date of an offer for an intangible instrument may be six months from the most recently placed offer. All offers may be active until cancelled or expired, although it is contemplated that offers may be active for a day or some other duration. Additionally, all active offers may be illustrated differently on the display in the online exchange network display for example, in a color that is different from all expired offers and closed offers. Other visual methods may be used to identify all or selective active offers, such as different size or style or font.

The information display also includes status messages that may be noted along side the intangible instrument.

In order to efficiently operate the system of the present invention, select operations may be outsourced to third parties, such as a patent data provider, payment processor, earnest or holding account partner, and provider of insurance directed to the ownership of the intangible properties and instruments.

Among those identified above, the many additional advantages to the present invention include the following. One advantage of the invention is that it will significantly enhance the likelihood that an intangible instrument is bought or sold in the marketplace. An added advantage of the invention is that it will integrate the current, mostly fragmented buyer market and seller market. An additional advantage of the invention is that it will integrate potential buyers and sellers through the online exchange network by actively connecting them through a complete listing of all intangible instruments such as the intellectual properties that resulted from a grant or registration issued by a government office. The government office may be that of a country or a region. For example, a patent grant may be issued by the United States Patent & Trademark Office. The European Patent Office has the power to grant patents for member states of the European Patent Convention. The Office for Harmonization in the Internal Market has the power to issue a Community Trademark registration effective in all member states of the European Union. A copyright registration may be issued by the United States Copyright Office. A further advantage of the invention is that it will provide a secure method for negotiating and completing transactions. Another advantage of the invention is that it will provide assurance for the bidder and seller that each has the proper information about the intangible instrument that is being transacted. An added advantage of the invention is that through the use of the system and network of the present invention, intangible instruments, and thereby various intangible properties will be evaluated in a more robust context. The resultant valuations can produce more commercially satisfying transactions and valuations that can be used as comparables in the marketplace.

An object of the present invention is to provide an open, on-line recordation of current bid, ask and transaction pricing of all intangible instruments including those issued for intellectual properties and in all countries worldwide.

Another object of the present invention is a brokerage service for the efficient sale (or lump sum exclusive license) of intangible instruments.

Another object of the present invention is to provide for anonymous bidding, standard legal documents, holding account, earnest fee and payment services, facilitated diligence, and insurance directed to the ownership of the intangible properties and instruments.

Another object of the present invention is to directly service parties subject to a transaction.

Another object of the present invention is to form strategic relationships with third parties to acquire necessary data and streamline internal processes.

Another object of the present invention is to provide an online exchange network to address the inherent lack of liquidity in the transaction of intangible instruments.

An object of the present invention is to provide intangible instrument pricing, party anonymity, confidentiality, and transaction efficiency.

Another object of the present invention is to meet the demands for low transaction costs and brokering assistance to close transactions on acceptable terms.

Another object of the present invention is to form strategic relationships with third parties to acquire necessary data and streamline internal processes according to the present invention.

An object of the present invention is to provide enhanced transparency of intangible instrument pricing.

An object of the present invention is to provide pricing data on intangible instrument transactions publicly available.

Another object of the present invention is to allow for an efficient, secure transfer of intangible instruments including exclusive licenses according to the present invention.

Another object of the present invention is to aggregate data on intangible instrument transactions.

Another object of the present invention is to provide brokering services to parties, such as buyers, sellers, licensees, and licensors.

Another object is to provide a standardized system for transactions of intangible properties and instruments.

An added object is to produce commercially useful valuations of intangible instruments.

Yet another object of the present invention is to a global data source for browsing data relating to intangible properties and instruments. A further object is to allow the public to browse and search through at least some of the data generated through the use of the system without registration with a clearing house.

Another object of the present invention is to assist in understanding the market for intangible instruments, such as identifying value of global intellectual property and improved market efficiency.

Further aspects of the invention will become apparent from consideration of the drawings and the ensuing description of preferred embodiments of the invention. Although the embodiment described below is in reference to patents, a person skilled in the art will realize that other types of intangible instruments, for example, those directed to trademarks or copyrightable subject matter or other intangible property rights are possible and that the details of the invention can be modified in a number of respects, all without departing from the inventive concept. Thus, the following drawings and description are to be regarded as illustrative in nature and not restrictive.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

FIG. 1 is a screen shot of one embodiment of an informational display for an online exchange network according to the present invention;

FIG. 2 is a flow chart of one embodiment of a valuation exercise according to the present invention;

FIG. 3 is a flow chart of one embodiment of a bidder initiated transaction process according to the present invention;

FIG. 4 is a flow chart of an embodiment of a seller initiated transaction process according to the present invention; and

FIG. 5 is a block diagram of a computer system that implements one embodiment of the present invention.

### DETAILED DESCRIPTION OF EMBODIMENTS OF THE INVENTION

In the following, the present invention will be described with reference to an intellectual property, specifically a patent. However, the system and methods of the present invention permit transactions to be conducted with respect to a wide range of intangible properties and intangible instruments. The present invention will be further described with reference to an online exchange network, however, the system and methods of the present invention may be conducted in a trading venue such as a trading floor.

One preferred embodiment of the present invention is a system that includes a series of displays 30, or screens, that may be made available online and by which a party can identify, and view current bid and ask prices for a certain intangible instrument. Embodiments of the present system include those in which the intangible instruments that are displayed are directed to, for example, non-expired patents such as those being in-force within the last three years.

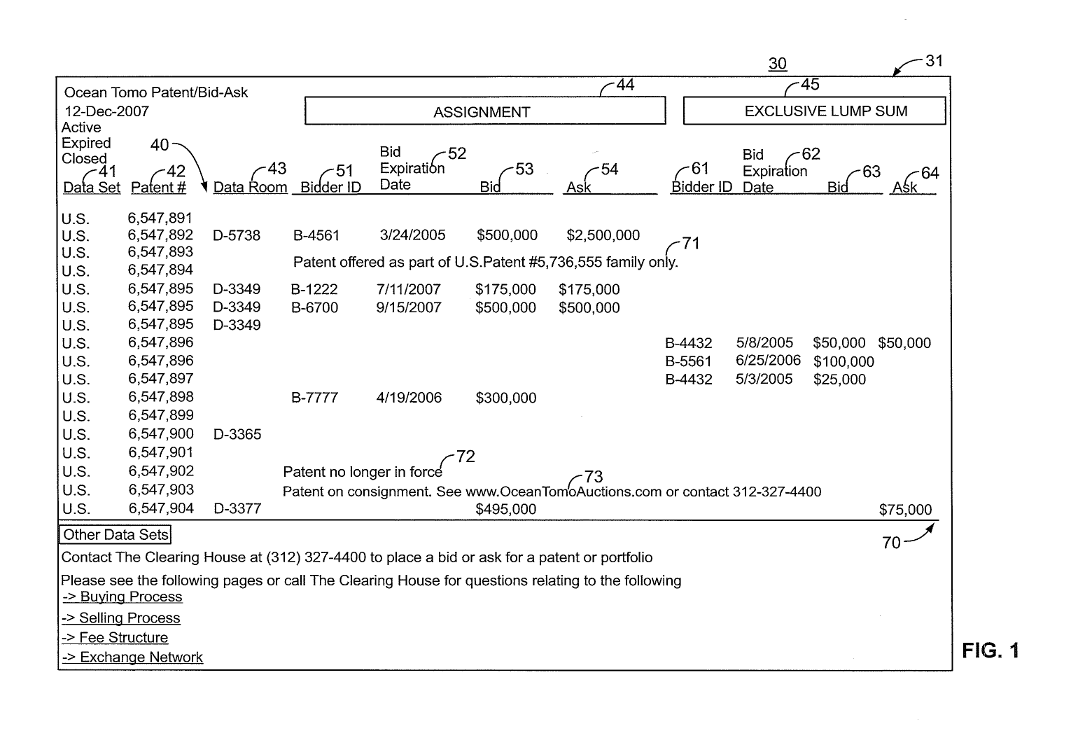

FIG. 1 is a screen shot of one embodiment of an informational display 31 for the online exchange network according to the present invention. A party may enter an intangible instrument identifier, such as a patent number, patent application number, or patent publication number, to view or scroll through all non-expired patents. As shown in the FIG. 1 embodiment, the informational display 31 includes fields 40, such as data set 41, patent number 42, data room 43, assignment 44, and exclusive lump sum 45.

The data set field 41 can include the relevant national, regional, or international patent office, such as the patent office of the United States, Canada, China, Germany, or Japan, or the European Patent Office, that is associated with the asset identifier 42 listed, here a patent number.

The data room field 43 is populated when due diligence materials, for example, licenses, liens, and/or litigation materials, are posted for the asset identifier 42 listed.

The assignment field 44 and exclusive lump sum field 45 further include bidder identification field 51, 61, bid expiration date field 52, 62, bid field 53, 63, and ask field 54, 64. The bid fields 53, 63 and ask fields 54, 64 each displays the amounts offered for the outright sale or purchase of the patent under the assignment field 44 and the sale or purchase of an exclusive license to the patent under the exclusive lump sum field 45.

The informational display 31 further includes a bidder identification number 51, 61. Each bidding party is assigned a unique bidder identification number. It is contemplated that the same party may have multiple unique bidder identification numbers to protect the anonymity of a party's investing behavior, such as when a bidder may bid on multiple patents or patent families simultaneously. However, if a bidder is bidding on a family of patents the same unique bidder identification number 51, 61 can be posted for each patent of the family. A family of patents includes a “parent” patent from which priority is claimed for one or more “child” patents.

For every intangible instrument identifier, the expiration date is posted in the expiration date field 52, 62 provided an expiration date exists. For example, the expiration date of a bid directed to a patent may be six months from the most recently placed offer on the patent. In one embodiment, all offers are active until cancelled or expired, although it is contemplated that offers may be active for a day or some other duration.

Embodiments of the present invention may use color, font type, font size, or other visually distinguishable mechanisms to identify the status of an intangible instrument or the transaction on the informational display 31. For example, in FIG. 1, all “active” offers may be illustrated in green text and all expired offers may be illustrated in red text and all completed or closed offers may be illustrated in yellow text. Other color or visual arrangements may be used to identify and distinguish active, expired, and closed offers.

Certain embodiments of the information display 31 according to the present invention may also include status messages 70. For example, when an offer has been placed not just for a single patent but for a family of patents, the display may provide a notation along the side of or adjacent to the parent patent as shown by 71. Another status message 70 may include when the term of the patent has expired as shown by 72, including when a necessary maintenance fee has not been paid or is on consignment as shown by 73. These status message 70 are noted along side the corresponding patent 42.

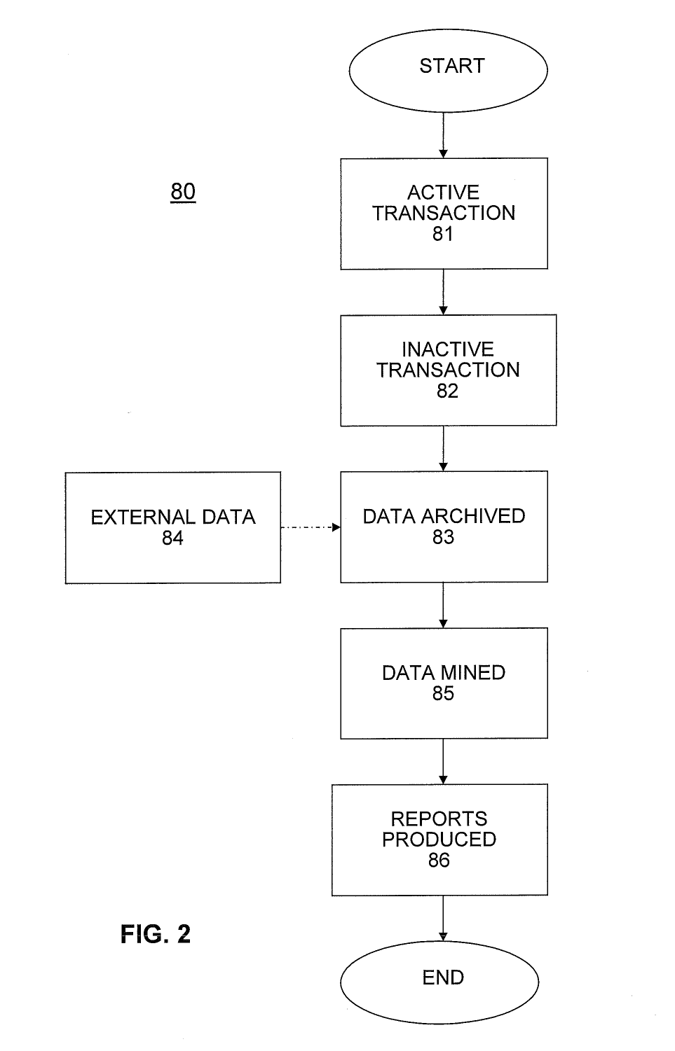

FIG. 2 is a flow chart of an embodiment of a valuation exercise 80 according to the present invention. Parties may browse and search through all data in the marketplace via a database. The clearing house archives data at step 83 in a database from the active transactions at step 81 where the offer for an intangible instrument is “pending” and the inactive transactions at step 82 where the offer for an intangible instrument has been accepted or the offer has been cancelled or expired. Data includes transaction activity such current and historic activity levels, bid/offer spreads, bid/offer frequency, number of bids/offers, bidder identities and bidder patterns to name a few.

In this embodiment, the clearing house archives data in the database from external sources at step 84, for example, information regarding intellectual property not subject to the exchange network. Browsing and searching through the database includes data mining at step 85. Data mining at step 85 allows a party to sort through large amounts of data and pick out data of interest, or relevant data. Data mining at step 85 may include filters to assist a party in precisely sorting through the data to find only certain information. The present invention allows parties to browse and search through all data in the marketplace via the database.

At step 86, reports may be produced from processing the data. Parties may have unrestricted access to the report whereas the public may be required to purchase the report from the clearing house. Reports may include, for example, limitation of license terms and how those limitation affected value of the intangible property or instrument and further in certain markets. Another example of a report may include the amount received by a Japanese patent directed to a certain subject matter such as microbiology in comparison to the amount received by a United States patent of the same patent family or of a different patent family, but relating to the same subject matter. Reports may also include intangible property trends or evaluations for intangible instruments in different geographic areas.

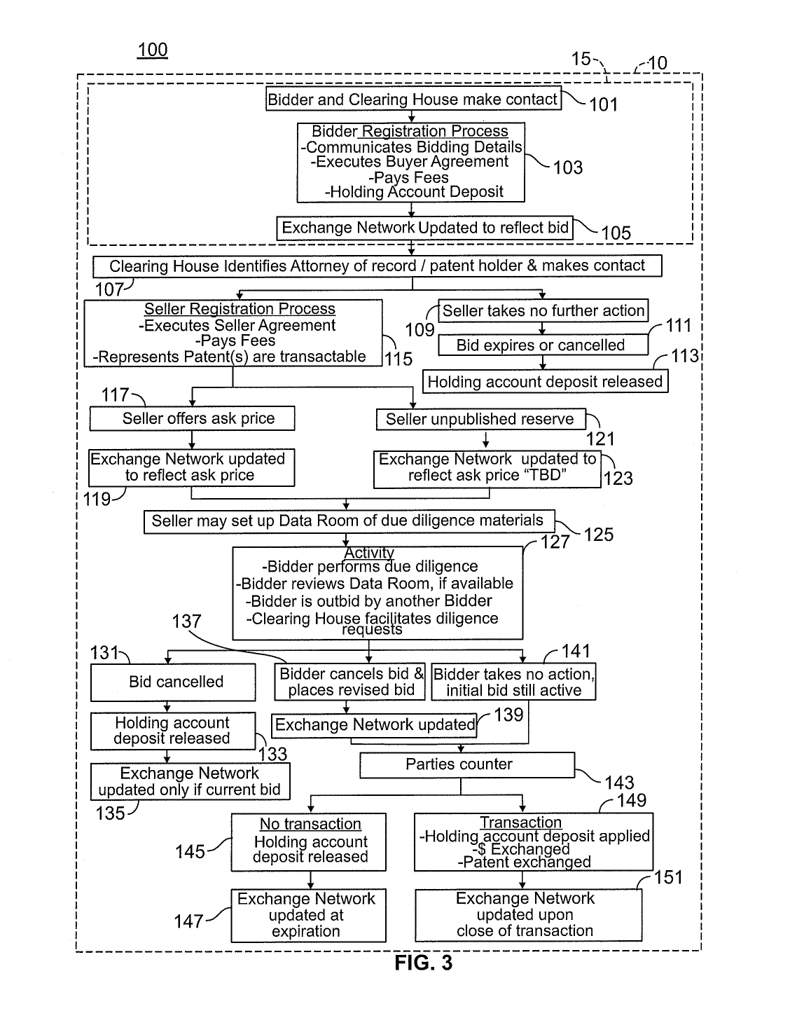

FIG. 3 is a flow chart of an embodiment of a bidder initiated transaction process 100 according to the present invention. The bidder initiated transaction, including all steps described below, may occur through a clearing house 10 either on-line or directly such as via phone or a mix of various communication systems. Bidders will be able to place a standard or non-standard transaction such as a bid to purchase or exclusively license an intangible instrument such as a patent, family of patents, or portfolio of patents. A potential buyer may be able to view the current bid and ask for a patent online.

Certain embodiments of the present invention permit a bidder to browse and search a collection or a database of intangible instruments through the displays of the online exchange network without registering with the clearing house 10 that operates and manages the online exchange network. The exchange network may contain all or some subset of intellectual properties, such as patent assets, issued by one or more national, regional, or international patent offices. The resultant displays may include intellectual properties that sellers have not identified as being “for sale.” The bidder may further perform a due diligence analysis on the intellectual property of interest.

If the bidder is interested in engaging in a transaction for a particular patent(s), such as purchasing or exclusively licensing a particular patent, the contacts the clearing house 10, such as online or via a toll-free number shown at step 101 of FIG. 3. After contacting the clearing house 10, the clearing house 10 may explain the available transactions and register the bidder at step 103. Registration of the bidder may include collecting some or all of the following information: customer or agent name; customer or agent address; customer or agent phone number; customer or agent email address; patent(s) of interest; bid amount; bid instructions; customer credit information; account information; and, customer preferences, or others.

During registration, the clearing house 10 further informs the bidder of bidding fees, earnest fees, and additional services. For example, if the bidder wishes to bid on a single patent, the bidding fee may be $250 and the earnest fee may be 10% of the bid amount. If the bidder wishes to bid on multiple patents, the clearing house 10 will determine if the patents belong to a single patent family or multiple patent families. Patents may be grouped together if they belong to the same patent family including the same assignee. The bidding fees may be the same for each patent grouping, for example $250 per patent grouping. Additional services may include services relevant to due diligence such as Ocean Tomo Analytics, Valuation services or Patent Ratings® reports.

After the bidding fee and earnest fee has been calculated, a notification, such as via email, may be sent to the bidder including an invoice and a bidder agreement. The email may further include a link to an online payment processing system such as one that accepts credit cards, debit cards or wire transfers. Upon completing the online payment processing and accepting the terms of the buyer agreement, registration is complete.

The earnest fee is placed in an account, such as a holding account with a third party or a third party bond service. Upon notification that the earnest fees have been received and the amount is correct, the display 30 of the exchange network (see FIG. 1) is updated at step 105 to include the bidder's bid and initiates the seller contact process at step 107. It is contemplated that a minimum bid is required for acceptance through the online exchange network, for example, $1000 per patent or family of patents.

The public, or potential buyers and potential sellers, may browse the displays 30 (FIG. 1) of the exchange network for transaction activity for all intangible instruments as shown by 15. The seller contact process at step 107 includes identifying the representative of the seller, such as the registered attorney of record, such as by using a third party or in-house database. This information may further be entered into a contact database. The clearing house 10 may correspond with the representative by a letter sent certified mail. It is further contemplated that the seller may be contacted depending on availability. The sellers and/or agents are notified that a party is interested in purchasing or exclusively licensing their patent(s) along with the bid amount placed by the bidder. The seller may have a time period for communicating that the seller is interested, such as six months from the mailing or receipt of the certified letter.

If the seller is not interested, the seller takes no further action at step 109 and at step 111 the bid is cancelled or the bid may expire, for example, six months from the bidder's bid on the patent. Upon cancellation or expiration of the bidder's bid, the earnest fee is released from the holding account at step 113. Certain embodiments of the present invention permit the clearing house 10 to take a portion of the earnest fee before returning it, such as to cover the transaction costs.

If the seller is interested, the clearing house 10 may explain the available transactions and register the seller at step 115. Included in explaining the available transactions, the seller is informed that the bid is contingent upon any liens or encumbrances on the patent(s), which is further described in the seller agreement. The seller may be required to provide a written representation—such as an affidavit—that there are no liens on the patent(s) and that they have the right to sell the patent(s).

During registration, the clearing house 10 further informs the seller of selling fees and additional services. After the selling fees have been calculated, a notification, such as via an email, is sent to the seller including an invoice and a seller agreement. The email may further include a link to an online payment processing system, such as one that accepts credit cards, debit cards, or wire transfers. Upon completing the online payment processing and accepting the terms of the seller agreement, registration is complete.

After registration of the seller at step 115, the seller may provide a firm published asking price for the patent(s) at step 117 or an unpublished minimum reserve price for the patent(s) at step 121. The clearing house 10 updates the display 30 (see FIG. 1) at step 119, 123 respectively. The asking price, or offer, may be active for six months or until cancelled by the seller.

At step 125, the seller may set up a data room of due diligence materials such as licenses, liens, and/or litigation materials. The seller may elect to put some or all of the materials in the data room. If the seller does not put any due diligence materials in the data room, the seller may be required to provide a written representation—such as an affidavit—that there are no liens on the patent(s) and that they have the right to sell the patent(s). The data room is available to all potential buyers, although it may only be accessible to a bidder that places a bid. The data room may be operated and managed by the clearing house for a data room fee, for example, $495. It is contemplated that data rooms provide a secure, central location in which sellers can post and potential buyers can access information materials and documents relevant to a possible transaction.

At step 127, various activities are performed, such as the bidder performs due diligence, the bidder reviews the data room, the bidder is outbid by another bidder, or the clearing house facilitates data room request, to name a few.

Both the bidders and sellers may contact the clearing house 10 at any time regarding bids and asks, such as to lift an offer, hit a bid, change a bid, change an offer, or obtain a quote on the current market for a patent(s). As shown at step 131, the exchange network permits a bidder to cancel a current bid. As a result of the cancellation, the earnest fee is released from the holding account at step 133. A fee may be charged as a result of such cancellation. The display 30 (see FIG. 1) is updated at step 135. As shown at step 137, the bidder may cancel a current bid and place a revised bid. The display 30 (see FIG. 1) is updated at step 139. If the bidder takes no action at step 141, the bid remains active.

It is contemplated that the parties may counter bid and ask at step 143. If no transaction results at step 145, the bidder's bid is no longer active, and the earnest fee is returned. The bid and offer remain active until expiration at six months from placement, or until cancelled whereupon the display 30 (see FIG. 1) is updated at step 147. It is contemplated that the clearing house 10 may offer to extend the seller's listing beyond expiration as well as keep the data room active for a period of time such as six months.

If the bidder and seller agree to a purchase price for the patent(s), the clearing house 10 will initiate the transaction process at step 149, whereupon the bidder becomes a buyer of the intangible instrument. The earnest fees may be applied from the holding account toward the purchase whereupon money and the relevant patent rights are exchanged. Again, all or some portion of the patent rights may be the subject of the transaction. The display 30 (see FIG. 1) is updated at step 151.

The clearing house 10 may obtain a commission fee for closed transactions, for example, 15%. The transaction fee may be shared equally by the buyer and the seller, or licensor and licensee.

It is also contemplated that the clearing house 10 may assist the parties in various business activities such as recording the assignment at the national, regional, or international patent office, processing the transfer of title documents, and providing insurance directed to the ownership of the intangible properties and instruments. The clearing house 10 may further change service fees, such as $500, for some or all these business activities.

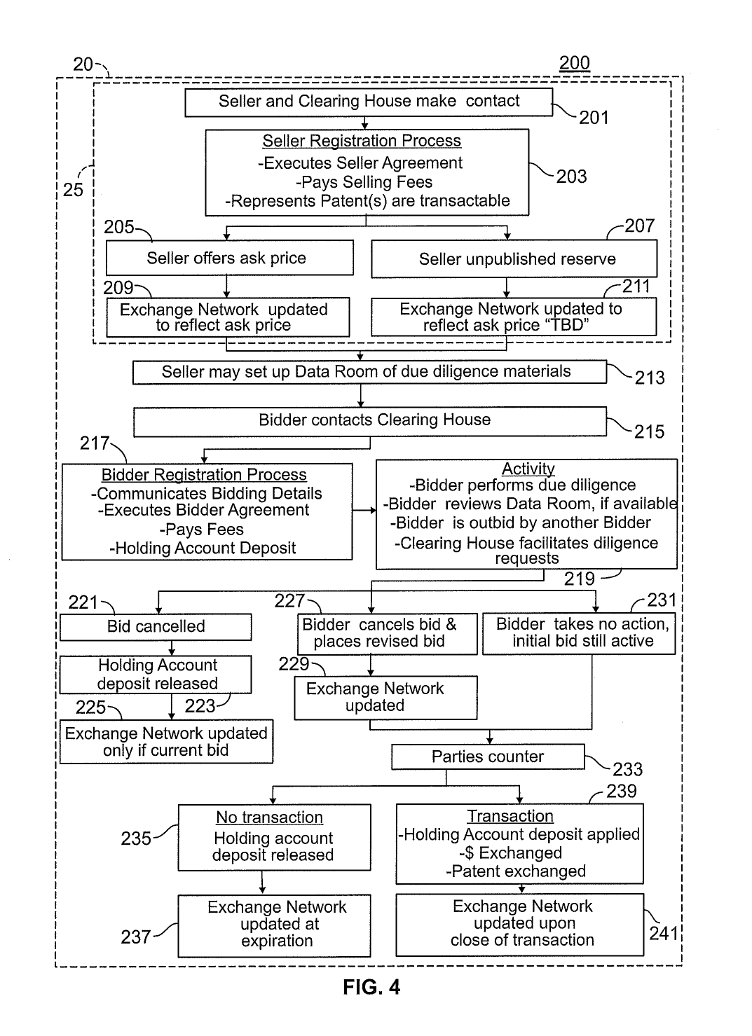

FIG. 4 is a flow chart of an embodiment of a seller initiated transaction process 200 according to the present invention. The seller initiated transaction, including all steps described below, may occur through a clearing house 20 either on-line or directly such as via phone or a combination of both or through other means of communication. Sellers will be able to place a standard or non-standard transaction such as an offer to sell or exclusively license an intangible instrument such as a patent, family of patents, or portfolio of patents. A potential buyer may be able to view the current bid and ask for a patent online.

A seller can browse and search a collection or database of intangible instruments through an online exchange network without registering with the clearing house 20 that operates and manages the online exchange network. The exchange network may contain all or some subset of intellectual property, such as patent assets, issued by one or more regional or international patent offices.

If the seller is interested in transacting on a particular patent(s), such as selling or exclusively licensing a particular patent, the seller contacts the clearing house 20, such as online or via a toll-free number shown at step 201 of FIG. 4 or a combination of both or through other means of communication. After contacting the clearing house 20, the clearing house 20 may explain the available transactions and register the seller at step 203. Registration of the seller may include collecting some or all of the following information: customer or agent name; customer or agent address; customer or agent phone number; customer or agent email address; patent(s) of interest; offer amount including either a firm offer and/or unpublished reserve price; account information; and, title history, or others.

During registration, the clearing house 20 further informs the seller of the selling fees and additional services. For example, if the seller wishes to sell a single patent, the selling fee may be $250. If the seller wishes to sell more than one patent, the clearing house 20 will determine if the patents belong to a single patent family or multiple patent families. Patents may be grouped together if they belong to the same patent family including the same assignee. The selling fees may be the same for each patent grouping, for example $250 per patent grouping. Additional services may include services relevant to due diligence such as Ocean Tomo Analytics, Valuation services or Patent Ratings® reports.

After the selling fees have been calculated, a notification, such as via email, may be sent to the seller including an invoice and a seller agreement. The email may further include a link to an online payment processing system such as one that accepts credit cards, debit cards or wire transfers. Upon completing the online payment processing and accepting the terms of the seller agreement, registration is complete.

After registration of the seller at step 203, the seller may provide an offer at step 205 such as a license, a firm published asking price for the patent(s). The party may define the terms of the license offered. For example, the licensor may limit the licensee so that no warranties, no representations and indemnification are provided thereunder. In one embodiment, the license is created by a party using an automated form system provided by the clearing house for use on the exchange network. The automated form may be customizable and include options selected via drop down boxes or links for terms of the agreement. In another embodiment, it is contemplated that the public can view all the options of the license as well as the option selected by the party. It is contemplated the automated form system provided by the clearing house for use on the exchange network may be used, for example, a party to prepare agreements or documents other than a license, for example, a non-disclosure agreement or a confidentiality agreement.

The seller may also provide an offer of an unpublished minimum reserve price for the patent(s) at step 207. The offer may It is contemplated that a minimum ask is required for acceptance through the online exchange network, for example $1000 per patent or family of patents.

The public, or potential buyers and potential sellers, may browse the displays 30 (FIG. 1) of the exchange network for transaction activity for all intangible instruments as shown by 25.

The seller may be required to provide a written representation—such as an affidavit—that there are no liens on the patent(s) and that they have the right to sell the patent(s). The clearing house 20 updates the display 30 (see FIG. 1) to reflect the ask price at step 209, 211 respectively. The asking price, or offer, may be active for six months, for example, from the date that the written representation is received by the clearing house 20, or until cancelled by the seller.

At step 213, the seller may set up a data room of due diligence materials such as licenses, liens, and/or litigation materials. The seller may elect to put some or all of the materials in the data room. If the seller does not put any due diligence materials in the data room, the seller may be required to provide written representation that there are no liens on the patent(s) and that they have the right to sell the patent(s). The data room is available to all potential buyers, although it may only be accessible to a bidder that places a bid. The data room may be operated and managed by the clearing house for a data room fee, for example $495. Data rooms provide a secure, central location allowing for information to be made available and accessed by the parties.

If a potential buyer is interested in transacting on a particular patent(s), such as purchasing or exclusively licensing a particular patent, the bidder contacts the clearing house 20 such as online or via a toll-free number or through some other communication system shown at step 215 of FIG. 4. After contacting the clearing house 20, the clearing house 20 may explain the available transactions and register the bidder at step 217. Registration of the bidder may include collecting the following information: customer or agent name; customer or agent address; customer or agent phone number; customer or agent email address; patent(s) of interest; bid amount; bid instructions; customer credit information; account information; and customer preferences to name a few.

During registration, the clearing house 20 further informs the bidder of bidding fees, earnest fees, and additional services. For example, if the bidder wishes to bid on a single patent, the bidding fee may be $250 and the earnest fees may be 10% of the bid amount. If the bidder wishes to bid on multiple patents, the clearing house 20 will determine if the patents belong to a single patent family or multiple patent families. Patents may be grouped together if they belong to the same patent family including the same assignee. The bidding fees may be the same for each patent grouping, for example $250 per patent grouping. Additional services may include services relevant to due diligence such as Ocean Tomo Analytics, Valuation services or Patent Ratings® reports.

After the bidding fees and earnest fees have been calculated, a notification, such as via email, is sent to the bidder including an invoice and a bidder agreement. The notification may further include a link to an online payment processing system such as one that accepts credit cards, debit cards or wire transfers. Upon completing the online payment processing and accepting the terms of the buyer agreement, registration at step 217 is complete.

At step 219, various activities are performed, such as the bidder performs due diligence, the bidder reviews the data room, the bidder is outbid by another bidder, or the clearing house 20 facilitates data room request, to name a few.

Both the bidders and sellers may contact the clearing house 20 at any time regarding bids and asks, such as to lift an offer, hit a bid, change a bid, change an offer, or obtain a quote on the current market for a patent(s). As shown at step 221, a bidder cancels a current bid. The earnest fee is released from the holding account at step 223 and the display 30 (see FIG. 1) is updated at step 225. As shown at step 227, the bidder cancels a current bid and places a revised bid and the display 30 (see FIG. 1) is updated at step 229. If the bidder takes no action at step 231, the bid remains active.

It is contemplated that the parties may counter bid and ask at step 233. If no transaction results at step 235, the bidder's bid is no longer active and the earnest fee is returned from the holding account. The bid and offer remain active until expiration at six months from placement, or until cancelled whereupon the display 30 (see FIG. 1) is updated at step 237. It is contemplated that the clearing house 20 may offer to extend the seller's listing beyond expiration as well as keep the data room active for a period of time such as six months.

If the bidder and seller agree to a purchase price for the patent(s), the clearing house 20 will initiate the transaction process at step 239, whereupon the bidder becomes a buyer. The earnest fees from the holding account may be applied toward the purchase whereupon money, and the patent are exchanged. The display 30 (see FIG. 1) is updated at step 241.

The clearing house 20 may obtain a commission fee for closed transactions, for example, 15% that may be shared equally between the buyer and seller, or licensor and licensee.

It is also contemplated that the clearing house 20 may assist the parties in various business activities such as recording the assignment at the regional or international patent office, processing the transfer of title documents, providing insurance directed to the ownership of the intangible properties and instruments. The clearing house may further change service fees, such as $500, for these business activities.

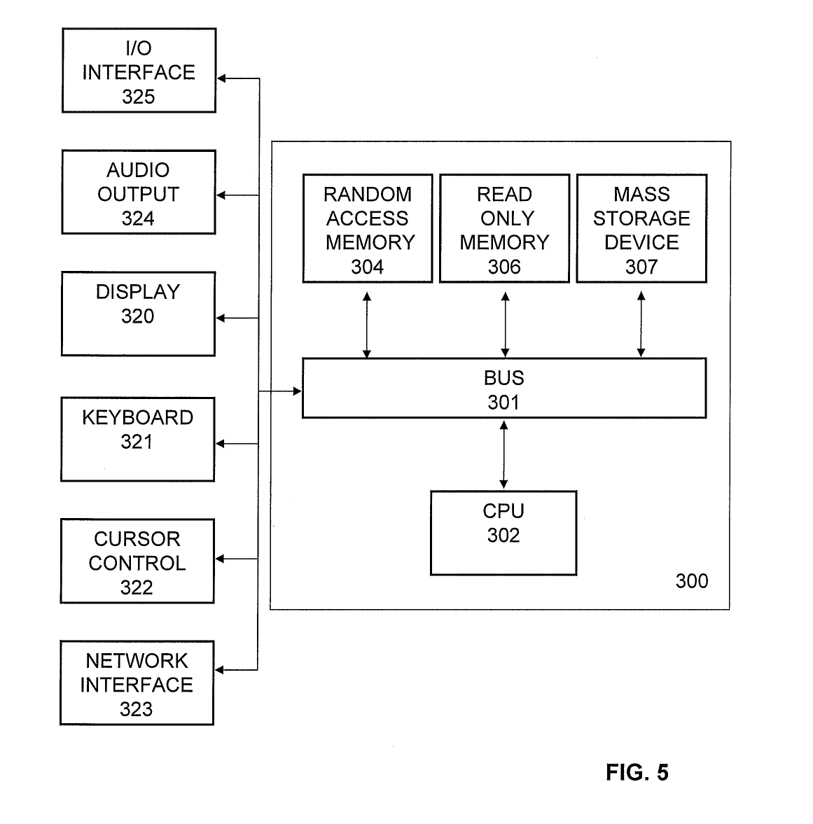

FIG. 5 is a block diagram of a computer system 300 that implements one embodiment of the present invention. According to one embodiment of the present invention, the steps of exchange network, as well as other aspects of the present invention are implemented by a computer system 300. The processor or central processing unit (CPU) 302 in the system 300 may execute sequences of instructions stored in a memory. The memory may be a random access memory (RAM) 304, read-only memory (ROM) 306, a mass storage device 307, or any combination thereof. The CPU is coupled through a bus 301 to the memory. The mass storage device 307 could be a disk or tape drive for storing data and instructions. The data may be further stored within a database in the mass storage device 307. Data and instructions may be loaded into the memory of the computer from a storage device or from one or more other computer systems over a network connection.

A display device 320 provides visual output of the informational displays of the exchange network and is also coupled to processor 302 through bus 301. The system 300 may further include a keyboard 321 for communicating information and command selections to processor 302. Another type of user input device may be a cursor control unit 322, which may be a device such as a mouse or trackball. Also coupled to processor 302 through bus 301 is an audio output port 324 for connection to speakers which output the audio content produced by computer system 300. Further coupled to processor 302 through bus 301 is an input/output (I/O) interface 325 which can be used to control and transfer data to electronic devices connected to computer 300.

Network interface device 323 is coupled to bus 301 and provides a physical and logical connection between computer system 300 and the Internet. The architecture of FIG. 5 is provided only for purposes of illustration, and that the computer system 300 used in conjunction with the present invention is not limited to this specific architecture.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A system for valuing and trading one or more intangible instruments, comprising:
a display device configured to illustrate one or more informational display screens, wherein the one or more informational display screens include:
an asset identifier field illustrating an identifier of an intangible instrument;
a data set field illustrating a national government office, a regional government office, or an international government office related to the intangible instrument;
a data room field illustrating and providing access to one or more due diligence materials related to the intangible instrument;
one or more bidder identification fields illustrating a unique identifier for a user; and
one or more bid fields and one or more ask fields, wherein the one or more bid fields and the one or more ask fields illustrate an offer by the user for the intangible instrument.

2. The system for valuing and trading one or more intangible instruments according to claim 1 further comprising an expiration date field illustrating a date upon which the offer for the intangible instrument expires.

3. The system for valuing and trading one or more intangible instruments according to claim 1, wherein the offer includes a value for a sale or a purchase of the intangible instrument.

4. The system for valuing and trading one or more intangible instruments according to claim 3, wherein the value is a monetary amount.

5. The system for valuing and trading one or more intangible instruments according to claim 1, wherein the offer includes a value for a license to the intangible instrument.

6. The system for valuing and trading one or more intangible instruments according to claim 5, wherein the license is an exclusive license.

7. The system for valuing and trading one or more intangible instruments according to claim 1 further comprising a status field illustrating one or more messages related to the intangible instrument.

8. The system for valuing and trading one or more intangible instruments according to claim 7, wherein the one or more messages communicates a maintenance fee related to the intangible instrument.

9. The system for valuing and trading one or more intangible instruments according to claim 7, wherein the one or more messages communicates a date on which the intangible instrument expires.

10. The system for valuing and trading one or more intangible instruments according to claim 1, wherein the identifier of the intangible instrument is a patent number, a patent application number, or a patent publication number.

11. The system for valuing and trading one or more intangible instruments according to claim 1, wherein the national government office, the regional government office, or the international government office is a patent office.

12. The system for valuing and trading one or more intangible instruments according to claim 1, wherein the one or more due diligence materials include a license, a lien, or a litigation document.

13. The system for valuing and trading one or more intangible instruments according to claim 1 further comprising an agreement information display screen illustrating an agreement related to the intangible instrument.

14. The system for valuing and trading one or more intangible instruments according to claim 13, wherein the agreement information display screen accepts language selected by a user through an online selection process to obtain selected language and illustrates the selected language within the agreement.

15. The system for valuing and trading one or more intangible instruments according to claim 13, wherein the agreement information display screen includes language for selection by a user to obtain selected language and illustrates the selected language within the agreement.
